(19) United States
(12) Patent Application Publication
(10) Pub. No.: US 2018/0076647 A1
(43) Pub. Date: Mar. 15, 2018

(54) HYBRID POWER BUCK-BOOST CHARGER

(71) Applicant: Intersil Americas LLC, Milpitas, CA (US)

(72) Inventors: Jia WEI, Cary, NC (US); Gary KIDWELL, Austin, TX (US)

(73) Assignee: Intersil Americas LLC, Milpitas, CA (US)

(21) Appl. No.: 15/701,178

(22) Filed: Sep. 11, 2017

Related U.S. Application Data
(60) Provisional application No. 62/394,116, filed on Sep. 13, 2016.

(51) Int. Cl. H02J 7/00; H02M 3/158

(52) U.S. Cl. CPC H02J 7/0068; H02J 7/007; H02J 7/0065; H02M 3/1582

(57) ABSTRACT

The present embodiments relate generally to managing power in a system including a battery, and more particularly to a flexible or hybrid battery charging topology for a system including a battery. In addition to being capable of operating in a conventional narrow voltage DC (NVDC) buck-boost charger mode, it is also capable of operating in a new “turbo power buck-boost” mode, where the input voltage is directly fed to the system load, bypassing the inductor. Compared with the conventional NVDC buck-boost charger topology, the flexible or hybrid topology provided by the present embodiments reduces the inductor size otherwise needed to support new mobile charging protocols, among many other benefits and advantages.

### CROSS-REFERENCE TO RELATED APPLICATIONS

The present application claims priority to U.S. Provisional Application No. 62/394,116 filed Sep. 13, 2016, the contents of which are incorporated by reference herein in their entirety.

### TECHNICAL FIELD

The present disclosure relates generally to power management, and particularly power management for a battery charger.

### BACKGROUND

Battery chargers, in particular battery chargers for mobile computing devices, are evolving beyond just being responsible for charging a battery when a power adapter is connected. For example, conventional mobile computing devices such as laptop or notebook computers include a dedicated and typically proprietary plug-in port for a power adapter. When the adapter is plugged in to this dedicated port, the battery charger is responsible for charging the battery using the adapter voltage specified by the manufacturer of the mobile computing device, in addition to controlling the supply of power to the system.

Recently, some mobile computing device manufacturers have moved toward replacing the typically separate and proprietary power adapter port with USB ports supporting the newer USB Type C (USB-C) or USB Power Delivery (USB PD) protocols. USB-C supports bi-directional power flow at a much higher level than previous versions of the USB interface (e.g. 5V). Starting from a default 5V voltage, the USB-C port controller is capable of negotiating with the plugged-in device to raise the port voltage to 12V, 20V, or another mutually agreed on voltage, at a mutually agreed current level. The maximum power a USB-C port can deliver is 20V at 5 A current, which is 100 W of power—more than adequate to charge a computer, especially since most 15-inch Ultrabooks require just around 60 W of power.

These new USB-C and other mobile charging protocols thus provide a wider range of variable input voltages (Vin) to a battery charging system, which presents challenges for existing buck-boost charger solutions based on a NVDC topology, among other things.

### SUMMARY

The present embodiments relate generally to managing power in a system including a battery, and more particularly to a flexible or hybrid battery charging topology for a system including a battery. In addition to being capable of operating in a conventional narrow voltage DC (NVDC) buck-boost charger mode, it is also capable of operating in a new “turbo power buck-boost” mode, where the input voltage is directly fed to the system load, bypassing the inductor. Compared with the conventional NVDC buck-boost charger topology, the flexible or hybrid topology provided by the present embodiments reduces the inductor size otherwise needed to support new mobile charging protocols, among many other benefits and advantages.

### BRIEF DESCRIPTION OF THE DRAWINGS

These and other aspects and features of the present embodiments will become apparent to those ordinarily skilled in the art upon review of the following description of specific example embodiments in conjunction with the accompanying figures, wherein:

FIG. 1 is a block diagram of a system having a battery and battery charger according to embodiments;

FIG. 2 is a block diagram of an example implementation of a battery charger according to embodiments;

FIG. 3 is a block diagram illustrating aspects of battery charger operations using an example NVDC buck-boost charger module according to embodiments;

FIG. 4 is a block diagram illustrating aspects of battery charger operations using an example Turbo buck-boost charger module according to embodiments;

FIG. 5 is a block diagram illustrating aspects of battery charger operations using an example Turbo buck-boost battery charger module according to embodiments;

FIG. 6 is a block diagram illustrating aspects of battery charger operations using an example Turbo buck-boost adapter module according to embodiments;

FIG. 7 is a block diagram illustrating aspects of battery charger operations using an example Turbo buck-boost battery charging module according to embodiments;

FIG. 8 is a block diagram illustrating aspects of battery charger operations using an example Turbo buck-boost supplemental power module according to embodiments; and

FIG. 9 is a flowchart illustrating aspects of battery charger operations using an example Turbo buck-boost charger module according to embodiments.

### DETAILED DESCRIPTION OF THE PREFERRED EMBODIMENTS

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

According to certain general aspects, the present embodiments provide a flexible or hybrid battery charging topology. In addition to being capable of operating in a conventional narrow voltage DC (NVDC) buck-boost charger mode, it is also capable of operating in a new “turbo power buck-boost” mode, where the input voltage is directly fed to the system load, bypassing the inductor. Compared with the conventional NVDC buck-boost charger topology, the flexible or hybrid topology provided by the present embodiments reduces the inductor size and improves efficiency, among many other benefits and advantages.

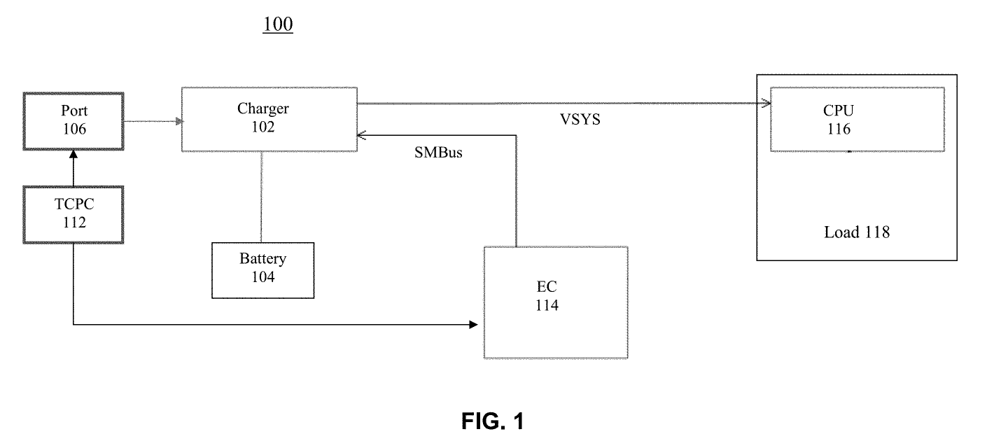

FIG. 1 is a block diagram illustrating aspects of incorporating the present embodiments in an example system 100. System 100 can be a mobile computing device such as a notebook computer (e.g. MacBook, Ultrabook, etc.), laptop computer, pad or tablet computer (iPad, Surface, etc.), etc. In these and other embodiments, system 100 includes CPU 116 running a conventional operating system such as Windows or Apple OS, wherein CPU 116 is a compatible x86 processor from Intel, AMD or other manufacturers, as well as other processors made by Freescale, Qualcomm, etc. It should be apparent that system 100 can include many other components not shown such as solid state and other disk drives, memories, peripherals, displays, user interface components, etc. According to certain aspects to become more apparent below, a system 100 in which the present embodiments can find particularly useful application has operational power needs that can exceed the power limits of technologies such as USB-A, for example over 60 watts. However, the present embodiments are not limited to applications in such systems.

As shown, system 100 includes a battery 104 and a battery charger 102. According to certain general aspects, during normal operation of system 100, when a power adapter is plugged into port 106, battery charger 102 is configured to charge battery 104. Preferably, in addition to charging battery 104, battery charger 102 is further adapted to convert the power from the adapter to a voltage suitable for supplying to load 118 of system 100, which system load can include CPU 116. According to certain other general aspects, during normal operation of system 100, when a power adapter is not plugged into port 106, battery charger 102 is configured to manage the supply of power to load 118 from battery 104.

Embodiments of battery charger 102 will be described in more detail below. In laptop, notebook or tablet computer (e.g. Ultrabook) and other embodiments of system 100, battery 104 can be a rechargeable 1S/2S/3S/4S (i.e. 1 cell, 2 cell, 3 cell, or 4 cell stack) Lithium-ion (Li-ion) battery. In these and other embodiments, port 106 can be a Universal Serial Bus (USB) port, such as a USB Type C (USB-C) port or a USB Power Delivery (USB PD) port. Although not shown in FIG. 1, switches between port 106 and charger 102 can also be provided for controllably coupling power from an adapter connected to port 106 to charger 102, or alternatively providing system power to charger 102 and/or port 106. Such switches can include or be implemented by active devices such as back-to-back FETs.

Still further, example system 100 in which the present embodiments can find useful applications includes a Type C port controller (TCPC) 112 and an embedded controller (EC) 114. According to certain general aspects relevant to the present embodiments, TCPC 112 includes functionality for detecting the type of USB device connected to port 116, controlling switches associated with connecting port 106 to system 100, and for communicating port status to EC 114 (e.g. via an I2C interface). EC 114 is generally responsible for managing power configurations of system 100 (e.g. power adapter connected or not connected to port 106 as communicated to EC 114 from TCPC 112, etc.), receiving battery status from battery 104, and for communicating battery charging and other control information to charger 102 (e.g. via SMbus interface).

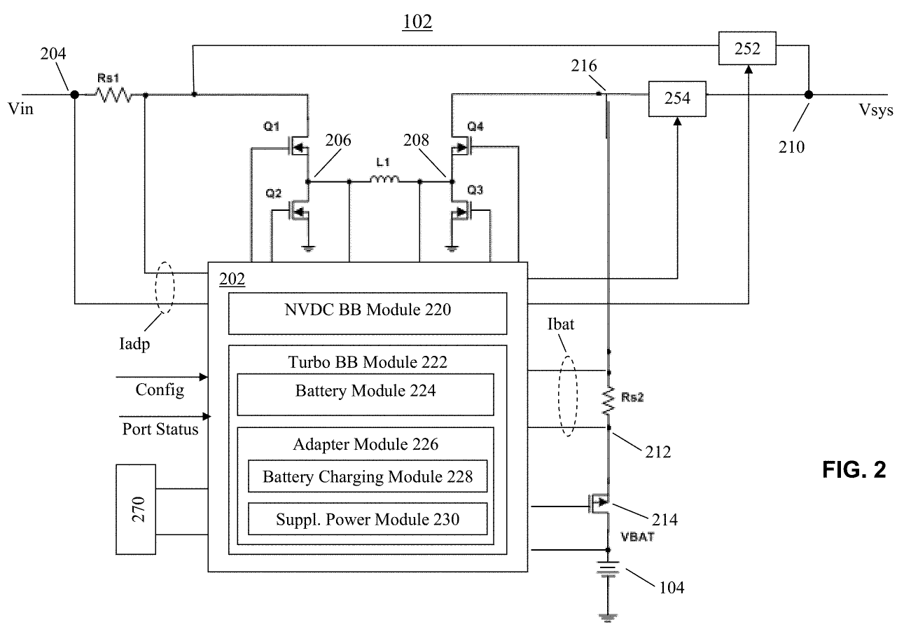

FIG. 2 is a schematic diagram of an example implementation of a battery charger according to the present embodiments using an integrated circuit 202. Those skilled in the art will be able to implement embodiments of the battery charger using a variety of other combinations of integrated and/or other circuits after being taught by the present examples.

As shown, input node 204 of charger 102 can be coupled to receive power from an adapter via port 106 (e.g. a USB-C port, not shown). In these and other embodiments, an adapter current (Iadp) sense resistor Rs1 is coupled between input node 204 and transistor Q1, and the voltages at either end of resistor Rs1 are provided to input pins or pads on IC 202.

As further shown, the example charger 102 in these embodiments includes a plurality of power switching transistors including a field-effect transistor (FET) Q1, having its drain coupled to resistor Rs1 and its source coupled an intermediate node 206. Another FET Q2 has its drain coupled to node 206 and its source coupled to GND. The charger 102 includes an inductor L1 coupled between node 206 and the node 208. The example charger 102 in these embodiments further includes FET Q4, having its drain coupled to charger node 216 and its source coupled an intermediate node 208. Another FET Q3 has its drain coupled to node 208 and its source coupled to GND. As shown, output node 210 provides a system voltage VSYS, which can be provided to a system load, such as CPU 116 (not shown).

Charger 102 in this example further includes a battery current (Ibat) sense resistor Rs2 coupled between charger node 216 and an intermediate node 212, with the voltages at these nodes being provided to input pins on IC 202. Another FET 214 has its source coupled to node 212 and its drain coupled to the rechargeable battery 104 developing the battery voltage VBAT. The gate of FET 214 is coupled to the IC 202 for controlling charge and discharge of the rechargeable battery 104. For example, when the power adapter is not connected, the FET 214 may be turned fully on to provide power to the system load via VSYS and charger node 216. When the power adapter is connected, the FET 214 may be controlled in a linear manner to control charging of the rechargeable battery 104 by power switching transistors Q1, Q2, Q3 and Q4 via charger node 216.

The FETs Q1, Q2, Q3, Q4 and 214 are shown implemented using N-channel MOSFETs, although other types of switching devices are contemplated, such as P-channel devices, other similar forms (e.g., FETs, MOS devices, etc.), bipolar junction transistor (BJTs) and the like, insulated-gate bipolar transistors (IGBTs) and the like, etc.

According to certain aspects, the illustrated arrangement of inductor L1 and switching FETs Q1, Q2, Q3 and Q4 implement a buck-boost (BB) topology. A BB topology can operate in buck mode when there is “input to output,” in boost mode when there is “output to input” or in buck-boost mode when there is two-way “input output.” More particularly, the four switching FETs Q1, Q2, Q3 and Q4 are grouped into a forward-buck leg (Q1 and Q2) and a forward-boost leg (Q3 and Q4). By operating either leg, this topology can be exploited by IC 202 to operate in forward buck mode or forward boost mode for charging the battery 104. It can also be caused to operate in reverse buck mode to deliver power out of the USB port 106 (not shown) for charging an external electronic device, such as a tablet, smartphone or the emerging portable power bank products that can charge any device.

As shown in FIG. 2, in addition to receiving signals representative of adapter current (Iadp) and battery current (Ibat), embodiments of IC 202 can further receive other signals and inputs. For example, as shown, IC 202 can receive a configuration input (Config). As described in more detail below, this input can specify whether to operate charger 102 as a NVDC BB charger or whether to operate charger 102 as a Turbo BB charger according to the present embodiments. As will be described in more detail below, this input can be provided by EC 114 (e.g. via SMbus interface) or it can be a hardwired input such as pinstraps. Many variations are possible.

As further shown, IC 202 can receive a Port Status signal, which can specify whether or not an adapter or other device is connected to port 106. This signal can be generated by EC 114 using information from TCPC 112, and provided via SMbus for example. As still further shown, in some embodiments such as that shown in FIG. 2, IC 202 can be connected to a hardware lookup table 270. As will be described in more detail below, this table can be used by IC 202 to control operations of charger 102 based on a comparison of the values in the table with other dynamically generated signals such as Iadp and Ibat, for example.

Among other things, the present applicant recognizes that, in existing BB charger solutions based on an NVDC topology, the inductor such as L1 needs to process both the battery charging current and the system load current. Meanwhile, with the newer protocols such as USB-C and USB PD, input voltages can range up to 20 V, and system power can range up to 100 Watts, even up to 300 Watts or more with some proprietary adapters. For such a range of voltages and power, the choice of the inductor becomes difficult due to the potential for high power ratings. This can lead to designs needing a large inductor size, which adds expense and further leads to higher power loss and low efficiency. Moreover, a wider range of output power capacitors (e.g. coupled between node 210 and ground, not shown) for supporting BB charger operations may be needed.

Therefore, according to additional aspects of the present embodiments such as the embodiment shown in FIG. 2, charger 102 includes switch 252 coupled between input node 204 and output node 210, and switch 254 coupled between charger node 216 and output node 210. As should be apparent, and as will be explained in more detail below, by virtue of this hybrid BB topology, when switch 252 is closed and switch 254 is open, power may be supplied directly from an adapter coupled to input node 204 to a system load coupled to output node 210, without requiring a current path through inductor L1 as in the conventional NVDC BB topology. Switches 252 and 254 are preferably implemented as back-to-back MOSFET pairs, but they can also be implemented by any type of switch, including solid state switch, mechanical switch or etc. They can be unidirectional or bidirectional switches. According to embodiments described in more detail below, the configuration of switches 252 and 254 are controlled by IC 202.

More particularly, in accordance with the above and other aspects, as shown, IC 202 according to the present embodiments includes a NVDC BB module 220 and a turbo BB module 222. In embodiments, modules 220 and 222 are activated for exclusively controlling operation of charger 102 in accordance with a conventional NVDC BB charger topology or in accordance with a Turbo BB charger topology according to the present embodiments, respectively. In example embodiments such as that shown in FIG. 2, modules 220 and 222 can be selectively activated for controlling operation of charger 102 in accordance with the Config input. As set forth above, this input can be provided via either software (e.g. SMBus signal from EC 114) or hardware (e.g. pinstrap).

As will be described in more detail below, when module 220 is activated, it controls operation of charger 102 as an NVDC BB charger. As further described in more detail below, when module 222 is activated, it can control operation of charger 102 in various modes depending on various circumstances, including controlling operation of charger 102 using either Turbo BB battery module 224 or Turbo BB adapter module 226 (which can further activate either Turbo BB battery charging module 228 or Turbo BB supplemental power module 230).

Aspects of how embodiments of the various modules of IC 202 control operation of charger 102, including the operation of transistors Q1, Q2, Q3 and Q4, in the above charger topologies and modes will become apparent from the following descriptions and drawings.

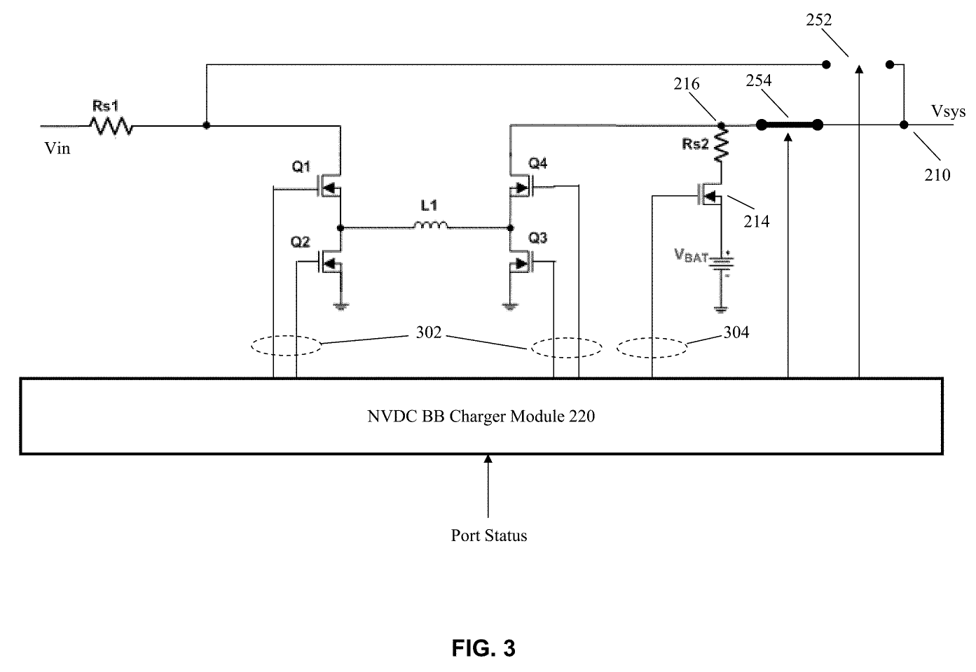

FIG. 3 is a block diagram illustrating an example operation of charger 102 when the NVDC BB charger module 220 is operative. During this mode of operation of charger 102, switch 252 is turned off (i.e. open) and switch 254 is turned on (i.e. closed). This configuration of switches 252 and 254 can be performed by signals from module 220 as shown in FIG. 3, or they can be configured by other circuitry in IC 202. As set forth previously, NVDC BB charger module 220 can configure charger 102 to operate as a conventional BB charger, perhaps in dependence on a port status signal.

For example, as set forth above, the four switching FETs Q1, Q2, Q3 and Q4 according to some embodiments are grouped into a forward-buck leg (Q1 and Q2) and a forward-boost leg (Q3 and Q4). By operating either leg, module 220 can operate the switching FETs Q1, Q2, Q3 and Q4 using signals 302 (e.g. PWM or PFM signals) in forward buck mode or forward boost mode for charging the battery 104 and providing power to the load via node 210 when the port status signal indicates that an adapter is connected.

When the port status signal indicates that an adapter is not connected, module 220 can cause the FET 214 to be turned fully on via signal 304 to provide power to the system load via charger node 216 and VSYS. When the power adapter is connected, module 220 can control FET 214 in a linear manner to control charging of the rechargeable battery 104 by power switching transistors Q1, Q2, Q3 and Q4 via charger node 216.

Module 220 can also cause switching FETs Q1, Q2, Q3 and Q4 to operate in reverse buck mode via signals 302 to deliver power out of the USB port 106 (not shown) for charging an external electronic device when the port status signal indicates that such a device is connected.

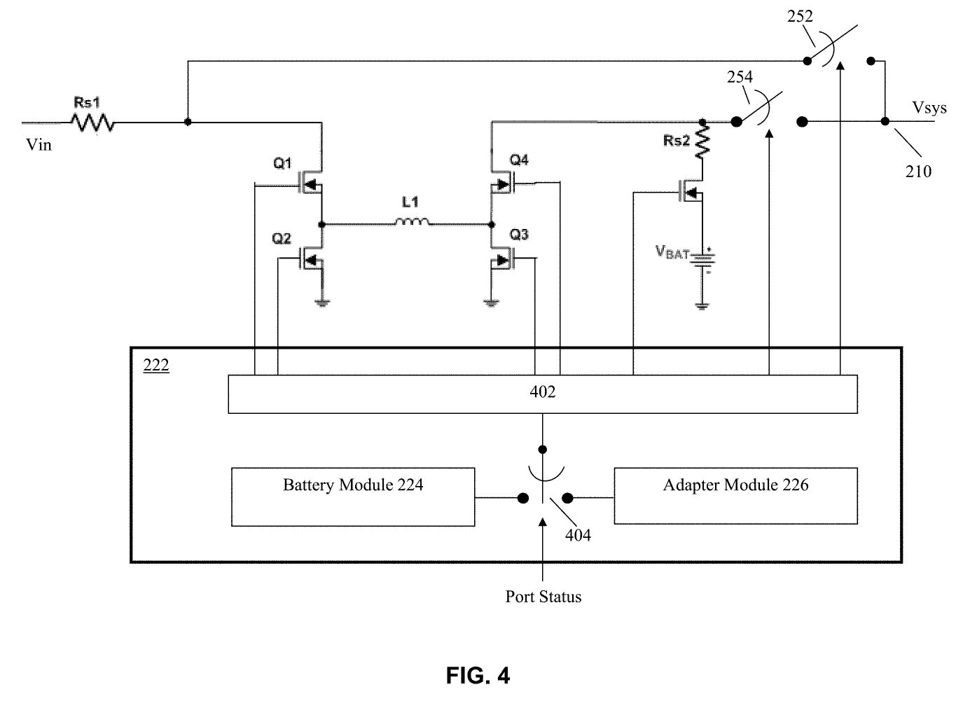

FIG. 4 is a block diagram illustrating an example operation of charger 102 when the Turbo BB module 222 is operative. As shown in this example, module 222 causes switch 404 to allow either Turbo BB Battery module 224 or Turbo BB Adapter module 226 to control operation of charger 102, including signal driving circuitry 402, in dependence on the port status signal. More particularly in this example, when the port status signal indicates that no adapter is connected to port 106, module 222 activates Turbo BB Battery module 224. Conversely, when the port status signal indicates that an adapter is connected to port 106, module 222 activates Turbo BB adapter module 226.

As further shown in this example, circuitry 402 provides access to either module 224 or 226 to signals for controlling operation of switching transistors Q1, Q2, Q3, Q4, switches 252, 254 and FET 214, as will be described in more detail below.

It should be noted, however, that when Turbo BB module 222 is operative, either switch 252 or switch 254 may be closed. According to certain aspects, during transitions between switch configurations, switches 252 and 254 preferably exhibit ideal diode behavior so as to prevent current from Vsys output capacitor(s) (not shown) traveling to either the adaptor or to the battery. This ideal diode behavior also eliminates the direct current path between the battery and adaptor. Likewise, during transitions between switch configurations, switches 252 and 254 both preferably also limit the inrush current from the adaptor/battery to Vsys, respectively.

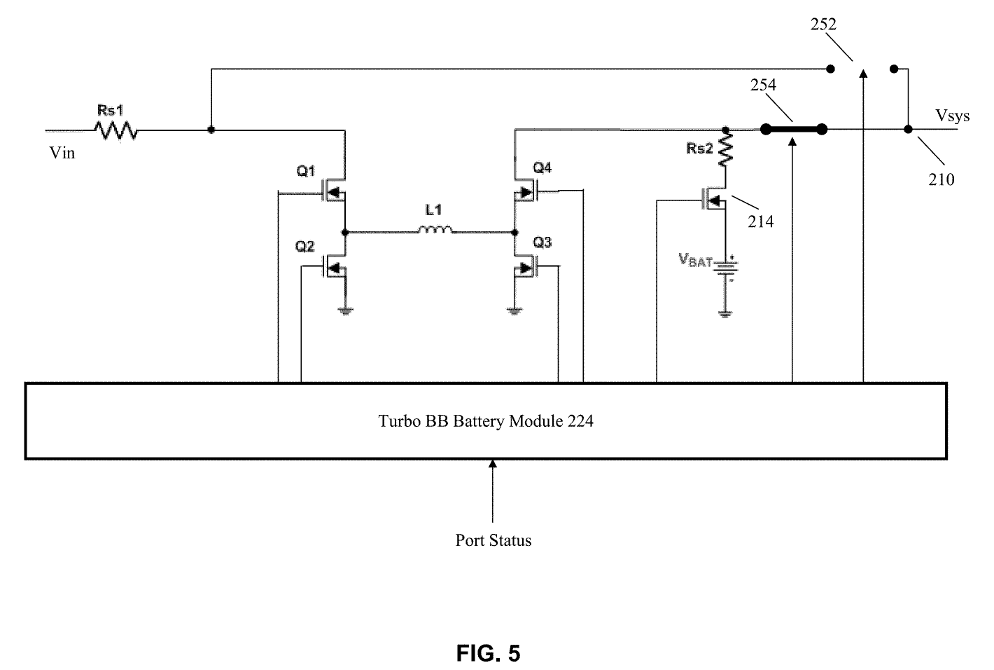

For example, FIG. 5 is a block diagram illustrating an example operation of charger 102 when the Turbo BB battery mode module 224 is operative as activated by module 222 as illustrated in FIG. 4, for example. During this mode of operation of charger 102, switch 252 is turned off (i.e. open) and switch 254 is turned on (i.e. closed). This configuration of switches 252 and 254 can be performed by signals from module 224 as illustrated in FIG. 5 (e.g. via circuitry 402, not shown) or they can be configured by other circuitry in IC 202, such as module 222.

In this mode, module 224 can operate switching FETs Q1, Q2, Q3 and Q4 in accordance with information supplied by the port status signal for example. For example, module 224 can turn off switching FETs Q1, Q2, Q3 and Q4 and turn on the BFET 214 (perhaps via circuitry 402, not shown) so that only power from the battery 102 is supplied to the output node 210 via charger node 216 if the port status signal indicates that no device is connected to USB port 106. In these and other examples, module 224 can also cause switching FETs Q1, Q2, Q3 and Q4 to operate in reverse buck mode to deliver power out of the USB port 106 (not shown) for charging an external electronic device when the port status signal indicates that such a device is connected.

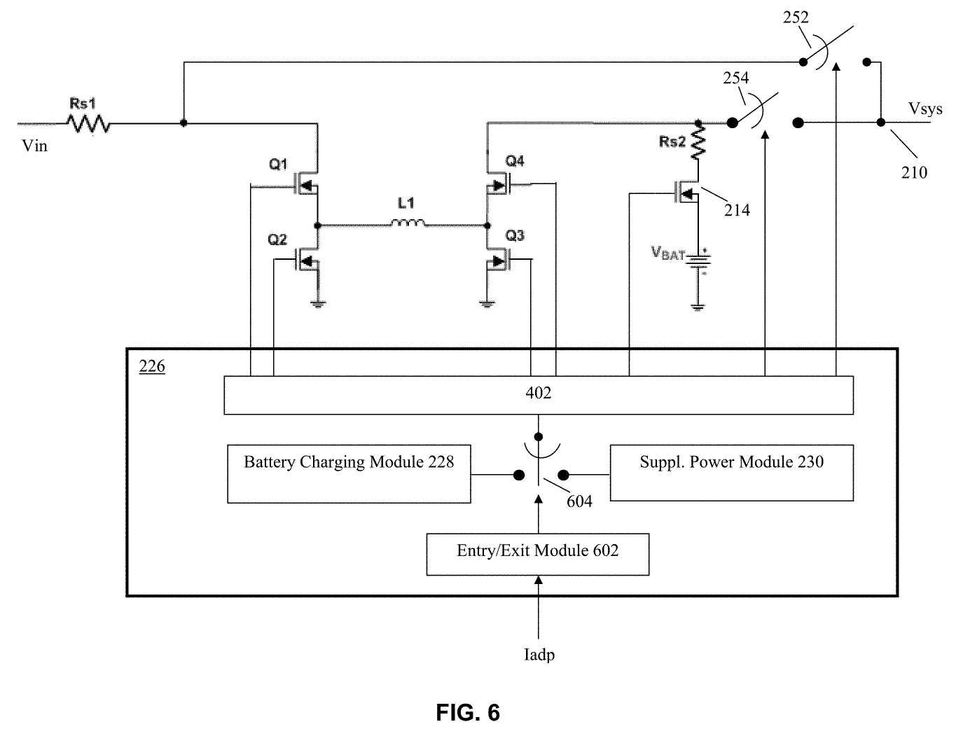

FIG. 6 is a block diagram illustrating an example operation of charger 102 when the Turbo BB adapter module 226 is operative, as activated by module 222 as illustrated in FIG. 4, for example. As shown in this example, module 226 causes switch 604 to allow either Turbo BB Battery charging module 228 or Turbo BB Supplemental power module 230 to control operation of charger 102, including signal driving circuitry 402, by operation of supplemental power entry/exit determination module 602, as will be described in more detail below. Similar to the embodiment shown in FIG. 4, in this example, circuitry 402 provides access to either module 228 or 230 to signals for controlling operation of switching transistors Q1, Q2, Q3, Q4, switches 252, 254 and FET 214, as will also be described in more detail below.

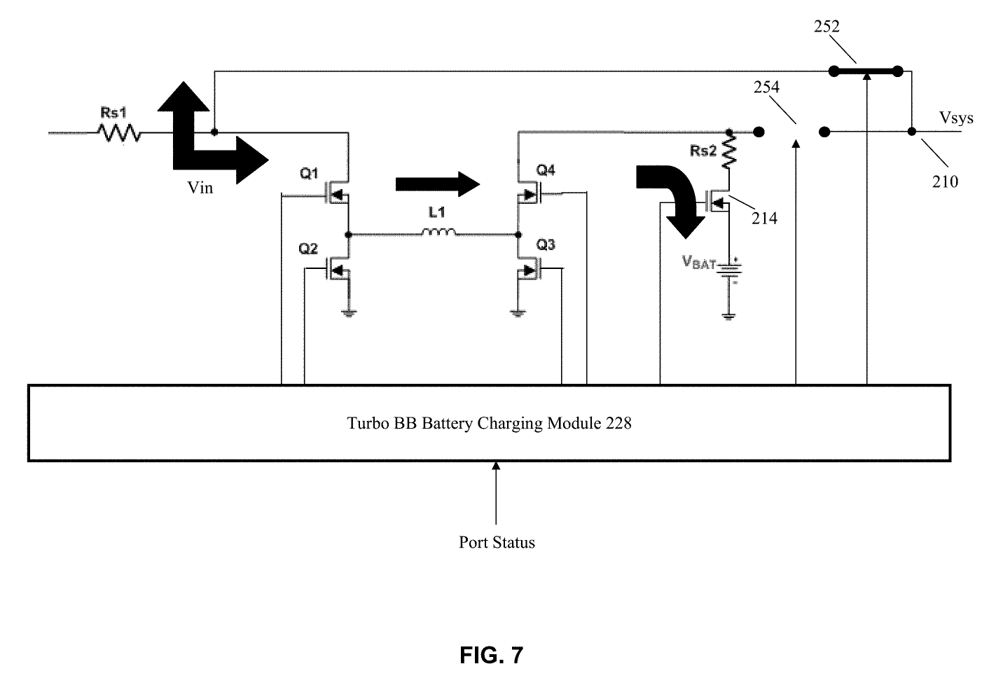

FIG. 7 is a block diagram illustrating an example operation of charger 102 when the Turbo BB battery charging module 228 is operative. As shown in FIG. 7, in this mode, switch 252 is turned on (i.e. closed) and switch 254 is turned off (i.e. open). This configuration of switches 252 and 254 can be performed by signals from module 228 as illustrated in FIG. 7 (e.g. via circuitry 402, not shown) or they can be configured by other circuitry in IC 202, such as in module 222 or module 226.

In this configuration, according to aspects of the present embodiments, Vin is directly fed to the system load. Module 228 turns on FET 214 and operates switching transistors Q1, Q2, Q3 and Q4 in forward buck, boost or buck-boost mode to charge the battery 104 as shown in FIG. 5. Module 228 can further cause FET 214 to be turned off and/or cause Q1, Q2, Q3 and Q4 to stop switching under certain conditions, such as when the battery is fully charged as indicated by the battery current signal Ibat.

Returning to FIG. 6, in embodiments, by default whenever module 222 is activated as described above, supplemental power entry/exit module 602 causes Turbo BB battery charging module 228 to be activated for controlling operation of charger 102 as described above. However, even while module 228 is controlling operation of charger 102, module 602 can remain active and can monitor and/or use various criteria to determine when to activate Turbo BB supplemental power module 230 for controlling operation of charger 102 instead of module 228.

In general, the criteria for determining activation of module 230 is established based on the system load being greater than the input power supply capability. This determination can be implemented in many different ways, as described in the following non-limiting examples.

In one example, module 602 monitors the input current from the adapter as indicated by the Iadp signal as described above. When the input current exceeds a set threshold (e.g. as determined from lookup table 270 or registers within IC 202), module 602 can set a timer for counting down a certain period of time. The timer can be a fixed timer or it can be a software configurable timer (e.g. via SMbus). If module 602 determines that the input current exceeds the threshold for the configured period of time, module 602 can cause Turbo BB supplemental power module 230 to control operation of charger 102 instead of module 228.

Alternatively to module 602 monitoring input power supply capability, this capability can be monitored by other circuitry, including circuitry outside of IC 202. For example, EC 114 can determine the capability of the adapter connected to port 106, and based on this determination can send a signal to IC 202 and module 602 (e.g. via SMbus) to activate Turbo BB supplemental power module 230 instead of module 228.

In yet another example, module 602 can determine whether to activate module 230 based on interaction with control loops within the charger 102. For example, in some embodiments, charger 102 has three potential control loops, namely adapter current loop, charging current loop, and charging voltage loop, in switcher forward mode. Each loop has an error signal, defined as “Error=Feedback−Reference”. A loop selector in module 602 according to these embodiments compares the three error signals and selects the loop with the smallest error signal as the control loop of the switching transistors.

In these and other embodiments, when battery charging module 228 is operative, if the total power from the adapter reaches the adapter wattage rating, the adapter current loop error reaches zero and is smaller than either of the other two loops, and so the adapter current loop takes control of the switching transistors, which means operating in adapter current limiting mode. If the total power from the adapter never reaches the adapter wattage rating, it will be a decision between the charging current loop and the charging voltage loop. When battery voltage is low, the charging voltage loop error is bigger, so the charging current loop take control of the switching transistors, which means operating in constant charging current mode. Once the battery is almost fully charged, the charging voltage loop error becomes smaller than the charging current loop, therefore the charging voltage loop takes control which means reduced charging current until it reaches zero (because the battery voltage rises to the set reference).

Entry/exit module 602 in these embodiments can use two possible approaches for making a decision on entering supplemental power mode and activating supplemental power module 230 when the total power from the adapter reaches the adapter wattage rating. In a first approach, the decision is based on when the adapter current exceeds the adapter current reference. This can be done with a filtering to ensure it is a legitimate condition and not a blip. Exiting the supplemental power mode would require the adapter current to drop below the reference, with filtering. In a second approach, the decision is based on when the adapter current exceeds the adapter current reference and the battery charging current has reduced to zero. In this situation, the switching transistors have essentially stopped charging the battery and let all the adapter power go to the load, and yet the adapter is still being overloaded, so the battery needs to help the adapter. Exiting the supplemental power mode in this approach would require the battery discharging current to reach zero (i.e. the adapter no longer needs help from the battery).

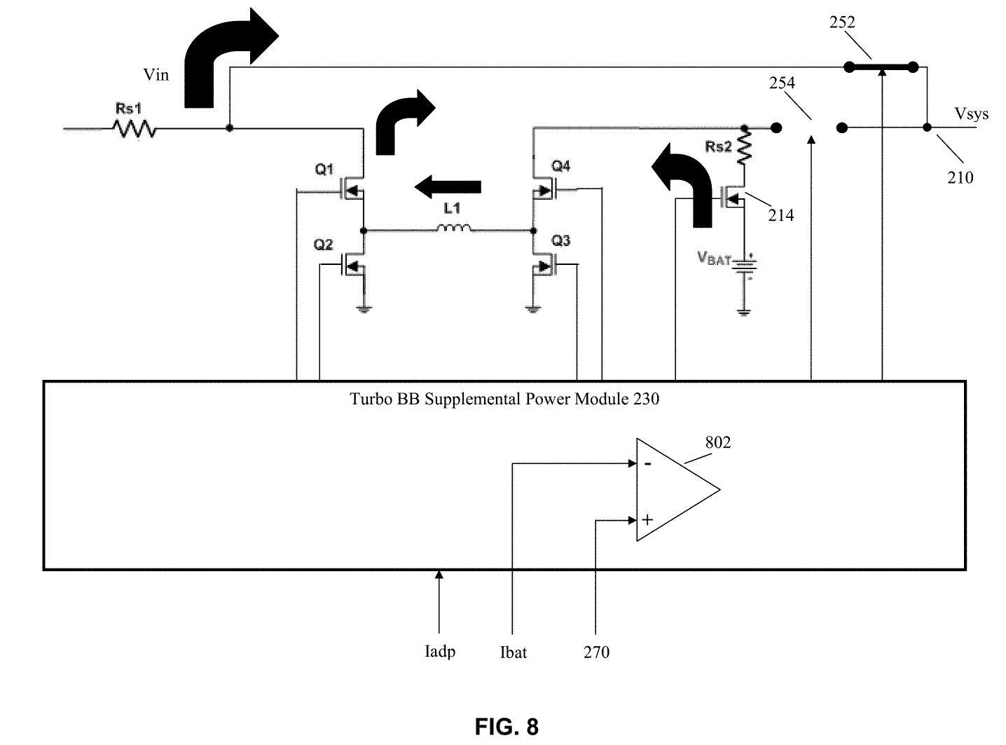

FIG. 8 is a block diagram illustrating an example operation of charger 102 when the Turbo BB supplemental power module 230 is operative, as activated by module 602 as described above. As shown in FIG. 8, in this mode, switch 252 is turned on (i.e. closed) and switch 254 is turned off (i.e. open). This configuration of switches 252 and 254 can be performed by signals from module 230 (e.g. via circuitry 402, not shown) or they can be configured by other circuitry in IC 202, such as in module 222 or module 226.

In Turbo BB supplemental power mode, during which the system load (e.g. including CPU 116) requires power more than the adapter capability as determined by module 602 as described above, module 230 turns on FET 214 and causes the battery to supplement the adapter by operating switches Q1, Q2, Q3 and Q4 in reverse buck, boost or buck-boost mode as shown in FIG. 8.

According to additional aspects, module 230 can monitor whether the system load (e.g. including CPU 116) requires more power than the total capability of both the input power supply and the battery. In this situation, module 230 according to the present embodiments can either regulate/limit the battery discharging current (e.g. to protect the battery) or to regulate/limit the input current (e.g. to protect the adapter).

For example, to regulate/limit the battery discharging current, module 230 monitors the battery discharging current Ibat and compares it with a set threshold (e.g. provided by software, such as a signal from EC 214, or by lookup table 270). Once the battery discharging current reaches the set threshold, module 230 uses a close loop control 802 to regulate/limit the battery discharging current at the set threshold. By doing so, the input current (as indicated by Iadp) may exceed its set threshold (e.g. provided by software, such as a signal from EC 214, or by lookup table 270).

To regulate/limit the input current, module 230 monitors the input current (as indicated by Iadp) and keeps it below a set threshold (e.g. provided by software, such as a signal from EC 214, or by lookup table 270) by allowing the battery discharging current indicated by Ibat to exceed its set threshold.

Another way module 230 can protect the adapter is to regulate/limit the input voltage droop. In this example, module 230 allows the load to draw current from the adapter until the input voltage Vin begins to droop. Thereafter, module 230 regulates/limits the input voltage Vin droop at a threshold (e.g. provided by software, such as a signal from EC 214, or by lookup table 270) by allowing the battery discharging current indicated by Ibat to exceed its set threshold (e.g. provided by software, such as a signal from EC 214, or by lookup table 270).

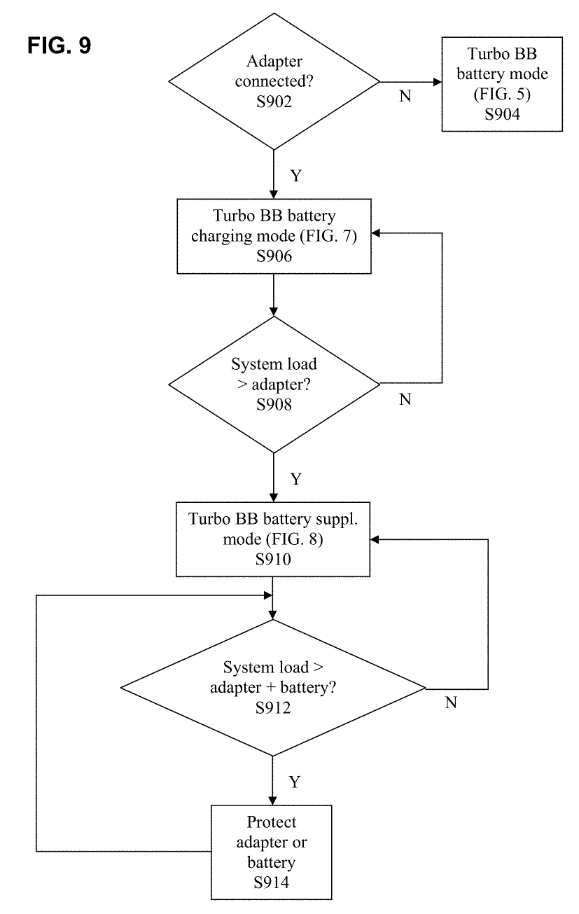

FIG. 9 is a flowchart of an example Turbo BB battery charging methodology according to the embodiments.

As shown in FIG. 9, a primary step S902 includes detection of a change in status of an adapter being connected to the battery charger, which can occur at any time during Turbo BB mode (and is not limited to just a single step in typical implementations). As set forth above, this can be signaled by EC 214 using SMbus, for example. If no adapter is connected, the Turbo BB battery module 224 is activated in step S904 and operations can be controlled as described in connection with FIG. 5.

Otherwise, the Turbo BB adapter module 226 is activated, and by default module 226 first activates the Turbo BB battery charging module 228 in step S906. Battery charger operations can then be controlled as described in connection with FIG. 7.

As set forth above, even while module 226 is operative, the Turbo BB adapter module 226 (e.g. entry/exit module 602) continuously monitors whether the system load is greater than the input power supply capability. This determination can be implemented in many different ways, as described above, such as by monitoring the input current from the adapter as indicated by the Iadp signal to determine when the input current exceeds a set threshold for a specified time. Alternatively to module 226 monitoring input power supply capability, this capability can be monitored by other circuitry, such as EC 114 based on the capability of the adapter connected to port 106. In yet another example, module 226 can interact with control loops within the charger 102 to determine when to enter supplemental mode.

If it is determined in step S908 that supplemental mode is needed, Turbo BB battery supplemental power module 230 is activated in step S910 and charger operations can be controlled as described in FIG. 8, for example. As set forth above in connection with this mode, module 230 can monitor when the system load exceeds the capabilities of both the adapter and the battery, and take actions as described above to protect the adapter or the battery in step S914.

Although not shown in FIG. 9, it should be noted that module 226 and/or module 602 can, while Turbo BB battery supplemental power module 230 is activated, continue to monitor system load conditions and, when load requirements have sufficiently dropped for a sufficient time, cause Turbo BB battery charging module 228 to be activated.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A battery charger comprising:
a narrow voltage direct current (NVDC) module that is configured to control switching transistors so as to cause power from an adapter to be supplied to a system load through an inductor; and
a switch that allows power from the adapter to be directly fed to the system load, bypassing the inductor.

2. The battery charger of claim 1, further comprising a turbo module that is configured to control the switching transistors and the switch, wherein only one of the NVDC module and the turbo module is operative to control the switching transistors at a given time.

3. The battery charger of claim 2, further comprising a configuration input for causing either the turbo module or the NVDC module to be operative.

4. The battery charger of claim 3, wherein the configuration input is a signal from an external source.

5. The battery charger of claim 3, wherein the configuration input is set by a pinstrap.

6. The battery charger of claim 2, wherein the turbo module includes a battery module that is configured to control the switching transistors to cause power from a battery to be supplied to the system load, and wherein the switch is open when the battery module is operative.

7. The battery charger of claim 2, wherein the turbo module includes a supplemental power module that is configured to cause power from a battery to supplement power from the adapter, wherein the switch is closed when the supplemental power module is operative.

8. The battery charger of claim 7, wherein the supplemental power module is further configured to protect the battery if the system load requires more power than a total capability of the adapter and the battery.

9. The battery charger of claim 8, wherein the supplemental power module protects the battery by regulating or limiting a discharging current of the battery.

10. The battery charger of claim 7, wherein the supplemental power module is further configured to protect the adapter if the system load requires more power than a total capability of the adapter and the battery.

11. The battery charger of claim 10, wherein the supplemental power module protects the adapter by regulating or limiting an input current of the adapter.

12. The battery charger of claim 2, wherein the turbo module includes a battery charging module that is configured to control the switching transistors so as to cause power from the adapter to charge a battery, wherein the switch is closed when the battery charging module is operative.

13. The battery charger of claim 12, wherein the turbo module includes a supplemental power module that is configured to cause power from the battery to supplement power from the adapter, wherein the switch is closed when the supplemental power module is operative, and wherein only one of the battery charging module and the supplemental power module is operative at a given time.

14. The battery charger of claim 13, wherein the turbo module further includes an entry/exit module that is configured to cause either the battery charging module or the supplemental power module to be operative.

15. The battery charger of claim 14, wherein the entry/exit module is configured to cause the supplemental power module to be operative instead of the battery charging module when an input current from the adapter exceeds a threshold for a predetermined amount of time.

16. The battery charger of claim 15, wherein one or both of the threshold and the predetermined amount of time are set by hardware.

17. The battery charger of claim 15, wherein one or both of the threshold and the predetermined amount of time are set by software.

18. The battery charger of claim 1, wherein the NVDC module is configured to operate in at least one of a buck mode, a boost mode or a buck-boost mode.

19. The battery charger of claim 2, wherein the turbo module is configured to operate in at least one of a buck mode, a boost mode or a buck-boost mode.
